(19) United States
(12) Patent Application Publication
(10) Pub. No.: US 2024/0070593 A1
(43) Pub. Date: Feb. 29, 2024

(54) APPARATUS, SYSTEM, AND METHOD FOR THE ACCESS-RESTRICTED PROVISION OF A TIME-DEPENDENT USAGE INDEX FOR A DEVICE

(71) Applicant: Siemens Aktiengesellschaft, Munchen (DE)

(72) Inventors: Wolfgang Bölderl-Ermel, Wendelstein (DE); Rene Ermler, Erlangen (DE)

(21) Appl. No.: 18/271,280

(22) PCT Filed: Dec. 3, 2021
(86) PCT No.: PCT/EP2021/084243

§ 371 Date: Jul. 7, 2023

(30) Foreign Application Priority Data
Jan. 11, 2021 (EP) 21150961.7

(51) Int. Cl. G06Q 10/0639; H04L 9/40

(52) U.S. Cl. CPC G06Q 10/06393; H04L 63/0435

(57) ABSTRACT

The disclosure relates to a method and a corresponding apparatus for allowing the introduction of pay-per-use models in the renting out of components in automation business. The challenge and the success in the introduction of pay-per-use models include appropriately addressing the conflict of interest between the protection of sensitive production data and the need to collect as much of the production data as possible for use as usage-relevant billing data. Therefore, a method is proposed that securely protects the data used and nevertheless allows the data to be reconstructed at a later time in the event of contentious questions.

The present patent document is a § 371 nationalization of PCT Application Serial No. PCT/EP2021/084243, filed Dec. 3, 2021, designating the United States, and this patent document also claims the benefit of European Patent Application No. 21150961.7, filed Jan. 11, 2021, which are incorporated by reference in their entireties.

### TECHNICAL FIELD

The disclosure relates to a method and a corresponding apparatus for allowing the introduction of pay-per-use models in the renting out of components in automation business.

### BACKGROUND

Traditionally, the manufacturers of machine tools sell them to the users of these machine tools. In this case, the procurement of the machine tools may be financed on credit and paid off within a period of five years, for example. In the calculation example, which makes 20 percent per year for the industrialist—plus the interest. For companies in volatile markets, the repayment may rapidly lead to a large burden.

A new financing model, “pay per use” is therefore becoming increasingly important for manufacturers in many fields of application. For the first time, there is actually enough real-time data available to offer manufacturers as providers and also the customers incorruptible basic parameters for correspondingly accurate billing.

The offer also affords many advantages for manufacturing firms, the advantages being both economic and technical in nature.

One advantage is that the firm is able to use the latest generation of machine tool, which is paid for according to utilization and may actually be returned if appropriate (for example if order books are empty). The customer may thus employ the newest generation of devices, which are firstly best benefit with regard to consumption of resources, and avoids capital being tied up in the long term by machines that remain unused. Payment is transparent, e.g., in the context of monthly billing.

An additional advantage is that future calculations and offers may be effected on the basis of the actual minute costs, which may also directly influence the unit cost accounting. After a contract has expired (or if orders fail to materialize), the machine may be returned or swapped for a new model.

A further advantage for the machine user is that a maintenance manager may be integrated in the machine, which ascertains and proposes the necessity of machine-dictated maintenance and servicing measures depending on use.

This networking and digitization makes the use data of machines more transparent:

The customer pays only for the useful operating time of the machine. The data concerning the useful operating time are acquired securely in the machine controller. The requisite IT infrastructure may be supplied via the Siemens IoT platform “Mindsphere,” for example. For connection to the Internet, an industrial PC, such as the Sinumerik Edge from Siemens, is interposed between machine controller and customer network, for example.

A basic prerequisite for this business model, however, is transparent and secure data management with information about the nature and extent of the actual use of the machine.

A major challenge here is that the data used is not accessible to unauthorized entities or even modifiable later.

For example, it is necessary to provide that no direct connection from the Internet to the machine is possible and that the data are encrypted with the highest security certificates.

The increase in use-based business models in the industrial sphere thus gives rise to the necessity of collecting and also evaluating use-relevant data from machines or installations for the machine owner.

These data are closely connected with the production process and therefore also include security-critical data for the customer, also called performance indicators hereinafter, such as (the enumeration may not be construed as exhaustive): production times and duration, processing speed, processing intensity, expended force, or number of parts produced.

These data thus also enable the unauthorized entity (for example a competitor) to draw diverse conclusions about processes and utilization on the part of the machine user and thus also possibly about the economic success of the latter.

The challenge and the success in the introduction of such pay-per-use models thus include primarily in appropriately addressing the conflict of interest between the protection of sensitive production data and the need to collect as many of the production data as possible for use as use-relevant billing data.

On the one hand, machine data may be regarded as a trade secret. Valuable details about the products and the production process may be derived from the data and these are therefore of interest, for example, to competing companies as well (e.g., in the context of industrial espionage).

On the other hand, in the case of a disagreement about the correct billing, the invoice issuer (owner) cannot fulfill the obligation to provide proof for the customer (user) if the invoice issuer does not have the detailed data necessary for this.

Both interests cannot be satisfied simultaneously in a trivial way.

One possible solution would be storage of all data on the part of the invoice issuer and imposition of access protection vis-à-vis the data (e.g., database rights management).

In the case under discussion here, this is acceptable only to a limited extent since access to the data base without the user's knowledge cannot be excluded (e.g., including as a result of software bugs, hackers, erroneous allocation of rights, insecure passwords). Furthermore, the database administrator may be a superuser and may access the data anyway, which is not desirable in this case.

It would also be conceivable to carry out a very early compression of the use data to form performance indicators (KPI, Key Performance Indicator) such as total operating time or use indices/degrees of use. One known example of such a procedure would be a “smart meter” (sealed intelligent electricity meter). That requires especially protected devices, however, which are tamperproof from an information technology standpoint and mechanically tamperproof.

A further possibility for solving the problem would be to encrypt the data base before transmission, surrender of the key being possible, and being done only in the case of dispute, for example. This procedure is very sensitive since after surrender of the key owing to a disputed invoice (and generation of a new key for the future), all older and future data may also be decrypted.

### SUMMARY

The problem addressed by the disclosure is that of specifying a method and an apparatus that solve the abovementioned problem of collecting and securely storing use data in a demonstrated scenario. The intention here at the same time is to satisfy the criteria enumerated below: the usability of use performance indicators by the invoice issuer is made possible; the integrity and the protection of all sensitive data of the user is ensured; the verifiability of the use performance indicators is implemented by the invoice issuer and the user jointly; and a finely granular release of sensitive data by the user in the case of dispute (in the context of billing) is possible.

The problem is solved by an apparatus, a system, and a method as disclosed herein. The scope of the present disclosure is defined solely by the appended claims and is not affected to any degree by the statements within this summary. The present embodiments may obviate one or more of the drawbacks or limitations in the related art.

The apparatus for the access-restricted preparation of a time-dependent usage performance indicator for a processing device in a production installation (K) for the further use of a first user, in particular, as a use-dependent invoicing basis for a second user, includes: a computer for determining the usage performance indicator from a determined, use-dependent, time-dependent measurement value concerning the device, the algorithm for calculation being known to the first user and the second user; and a key generator for producing a key index, and generating a symmetric key on the basis of the key index, for encrypting the at least one measurement value by the symmetric key, and transmitting the time-dependent usage performance indicator together with the encrypted measurement value and the key index in a data packet.

### BRIEF DESCRIPTION OF THE DRAWINGS

The disclosure is also illustrated below by way of the figures, which are intended to elucidate the concept of the disclosure, but do not per se constitute a limitation of the disclosure. In the figures, specifically:

FIG. 1 shows an example of the relationship between the device manufacturer and the user of the devices.

FIG. 2 shows an example of the method such as is performed in device 2.

FIG. 3 shows an example of the method act in device 1.

FIG. 4 shows an example of the method acts in device 3.

FIG. 5 shows an example of the division of the data D into data blocks.

FIG. 6 shows an example of the division of an individual data block.

### DETAILED DESCRIPTION

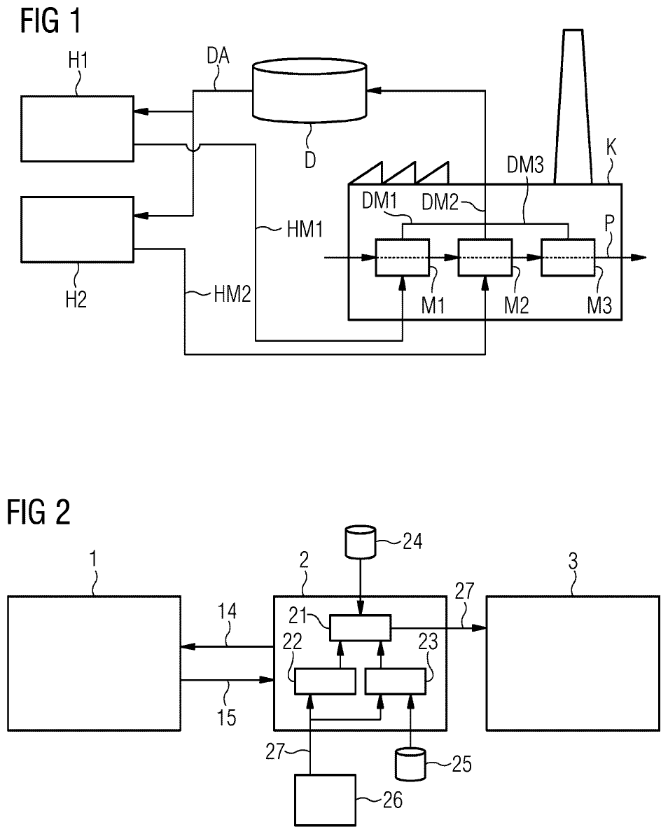

FIG. 1 shows an overview of the initial situation and the problem to be solved. A customer K, for example a manufacturer of specific goods P of arbitrary type, requires various processing devices, in particular machine tools M1, M2, M3, for the operation of its factory. These devices are produced by the device manufacturers H1, H2 and made available to the customer K for use in its factory.

In this case, the machine tools M1, M2, M3 are not purchased by the customer K, but rather made available on the basis of a pay-per-use contract. In this case, the billing of the usage is carried out on the basis of the operating data DM1, DM2, DM3 concerning the actual usage, the data being collected by the processing devices. The data may be stored in a database D, and the billing data DA securely produced therefrom in the method described further below are communicated to the manufacturers H1, H2. In this case, it is important that the recipient (and not actually any unauthorized third party) may recover the original operating data, e.g., from the billing data. However, the intention is nevertheless to make it possible at any time, if there is a compelling reason, including subsequently, to extract this data, for example, in the event of disagreements between manufacturer H1, H2 and customer K about the invoicing amount.

A system is proposed that includes three components: device 1, device 2, and device 3.

Device 1 produces a sequence of keys used to encrypt sensitive data.

Device 2, which acquires the data, forms the non-sensitive performance indicators 23 from the sensitive measurement data 27 determined by the sensor 26, and afterward sends the performance indicators 23 together with the measurement data encrypted by encryption method 22 to the owner. A configuration in device 2 stipulates how often a new key is requested by the device 1.

Device 3 is used supplementarily in order to store the use performance indicators and the encrypted measurement data of the user.

The provider/owner of the device in question may issue invoices to the user. In the case of dispute, the user grants access to measurement data in question.

FIG. 2 shows an overview of the interplay between the devices 1, 2, and 3, and also a detailed explanation of the functioning of the device 2.

Device 2 is an automation component, for example, which records measurement data 27 during operation for example by sensors 26 from the production process and compresses them using an algorithm 23 to form a performance indicator. The measurement data include values such as operating time, or operating duration, intensity, (energy consumption), parts produced (per unit time), speed, or the like.

The calculation algorithm ought not to have to be kept secret and is optionally coordinated between owner and user. Sums of times and integrals of consumption and loadings are used.

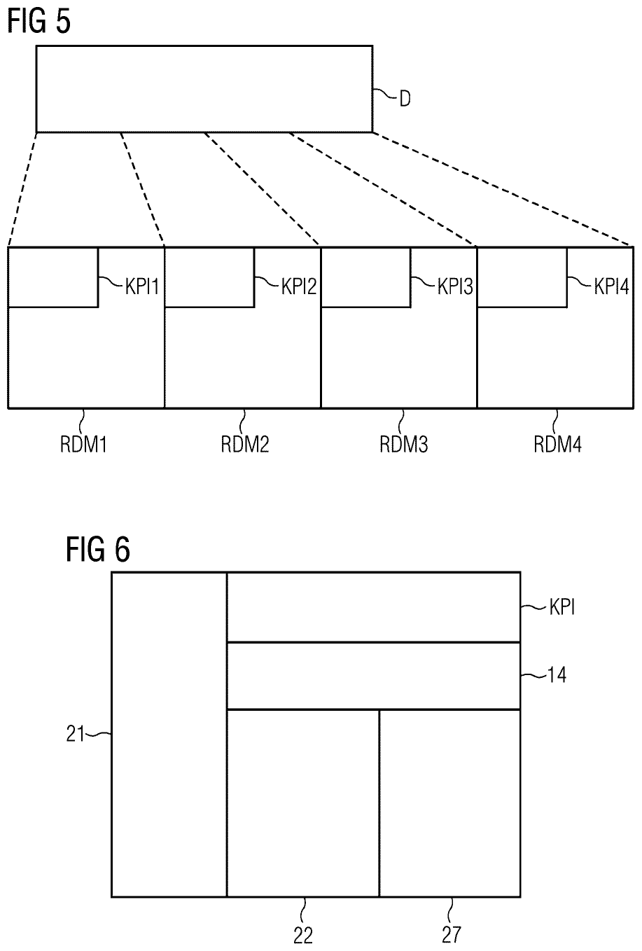

Before the data are transferred to the owner, a so-called key index (k-index) 14 as parameter is transferred to device 1 and a key is thereby produced and sent back 15 (KEYk-index) to the device 2. The entire message, which is illustrated in FIG. 6, then includes the measurement data 27 that have been symmetrically encrypted using the encryption method, the unencrypted KPI and the index of the used symmetric key, 14. The message is also signed, 21, and sent to the owner. The key is immediately deleted after use, because it is no longer required and may be produced again at any time with the aid of the device 1 given knowledge of the key index.

Depending on the case of use, in one advantageous embodiment, in the device 2 it is possible to adjust how often the keys are changed, e.g. once per day, once per work shift, or once per hour.

Depending on the frequency of key generation (week/day/shift/hour), it is possible to adjust very finely granularly how much information is protected by a key and thus also how much information is released by the transfer of an individual key.

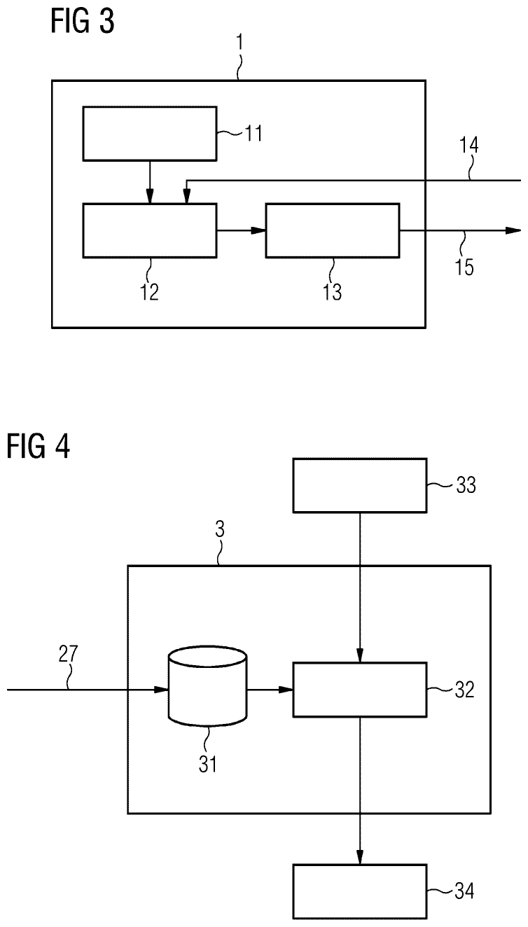

FIG. 3 shows the functioning of device 1, a key generator, which produces a series of symmetric keys with the aid of a start value 11 and a pseudorandom number generator (PRNG) 12. A design as a physical device (USB dongle, chip, or PLC module) may be advantageous in comparison to a pure software implementation in this case because the security of a PRNG resides in the secrecy of the start value. This may be achieved better with a physical device.

The use of a good pseudorandom number generator PRNG 12 on the one hand guarantees that further or previous keys cannot be deduced even from many known keys; on the other hand, with knowledge of the start value or ownership of the device, any required key 15 that was valid at a certain time may be ascertained, including subsequently. This is necessary if, for example, billing in the past is intended to be traced and the concrete measurement data 27 at a specific time have to be reconstructed again for this.

By way of example, a hashing function may be used as generating function 13. The block 13 prevents the generated random bits from becoming known in the device 2, which permits the internal start value of the device 1 to be deduced. Moreover, further data such as serial numbers (from device 2) or time stamps may influence the key generation. It is also advisable for the device 1 to limit the frequency with which key requests are answered, in order to combat a brute force attack that reads out a large number of keys.

The embodiment as a device (e.g., USB dongle, FPGA chip, or PLC assembly) is a security feature that protects the start value of the PRNG. The device may offer a possibility for initializing the start value but may not explicitly offer a function for outputting the start value.

The initialization of the start value may be performed by the user; knowledge about the generated keys on the part of unauthorized entities is thus absolutely precluded.

Instead of a device 1 for key generation, it is also possible to use a pure software implementation in device 2, although such an implementation is less secure since it cannot protect the start value of the random number generator PRNG as effectively.

Device 3 is illustrated schematically in FIG. 4; it operates as a billing system. This involves a database system that stores all messages created in the manner described above, 31, and allows accounting 32. For this purpose, the use performance indicators received from device 2 in the described form in accordance with FIG. 6 are converted into an invoice 34 in a suitable manner (e.g., in accordance with the use contract entered into between manufacturer H and customer K). Parameters 33 used in the drawing up may be: basic charges, use charges, high or low volume discounts, price reductions. The precise factors are part of the business relationship between owner and user, however.

If (for example at a later time) differences or doubts regarding the use performance indicators arise (put forward by owner or user), then the exact production of the invoice may be checked.

The invoice 34 is dependent on these three factors: (1) the measurement data 27, (2) the transformation of the measurement data into the performance indicators 23, and (3) the transformation of the performance indicators 23 into invoice amounts 32.

Because the measurement data 27 and the transformation of the measurement data into the performance indicators 23 are coordinated between the parties involved, only the measurement data 27 are required for the traceability of the invoice amounts. For this purpose, the owner requests from the user the required key(s) 15 (KEY k-index) therefor, which are not part of the original message and are stored in the database. The user obtains the latter from the device 1 by inputting the key index numbers k-index. The key Key _{k_index} (key with the number k_index) is requested. The original message and the database contain the k_index (the key number), but not the key itself. Correctness is verified by checking the KPI by a procedure in which the measurement values are decrypted therewith and the KPI is checked.

A “linear feedback shift register” may be used as a basis for a pseudorandom number generator PRNG. Here a polynomial of degree n (i.e., n+1 bits state) may be used to produce cycles of length 2n−1. http://courses.cse.tamu.edu/walker/csce680/lfsr_table.pdf

A polynomial of degree 63 therefore then produces 2⁶³−1 random bits. If 1024 (=2¹⁰) bits thereof, are in each case taken as input for the key generation, then 2⁽⁶³⁻¹⁾−1 keys may thereby be produced before the sequence of the random numbers is repeated.

A hypothetical change of key every minute requires 60*24*365=525600 keys per year (estimatable at the upper limit by 2¹⁹=524288).

Thus, the random number generator would not produce any repetitions in 2⁽⁶³⁻¹⁰⁻¹⁹⁾1=2³⁴ years.

Corresponding calculations may be carried out for other key lengths or change intervals in order to estimate the set of generatable keys.

The measurement values are thus encrypted with a multiplicity of different keys; the key space is more than large enough even in the event of a change every minute.

If a calculation according to the Blum-Blum-Shub method is chosen for the pseudorandom number generation PRNG, many iteration steps may be calculated simultaneously, which means an enormous time advantage in the production of the random numbers and hence the keys, particularly in the case of large indices. https://de.wikipedia.org/wiki/Blum-Blum-Shub-Generator

By contrast, a simple linear feedback shift register (LFSR for short) would have to be initialized with the start value and carry out all iterations up to the desired index (1024 steps per index). https://de.wikipedia.org/wiki/Linear_rückgekoppeltes_Schieberegister

The overall system offers integrated and automatic key generation. One advantage of the disclosure is that, apart from the start value mentioned above, no cryptographic material has to be stored or transmitted via insecure channels. Moreover, keys do not have to be stored and therefore cannot get into the wrong hands.

Depending on the frequency of key generation (week/day/shift/hour), it is possible to adjust very finely granularly how much information is protected by a key and thus also how much information is released by the transfer of an individual key.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An apparatus for access-restricted preparation of a time-dependent usage performance indicator for a processing device in a production installation, for further use of a first user and for a second user (K), the apparatus comprising:
a computer configured to determine the time-dependent usage performance indicator from a determined, use-dependent, time-dependent measurement value concerning the processing device, wherein an algorithm for calculation is known to the first user and the second user; and
a key generator configured to produce a key index and generate a symmetric key based on the key index, for encrypting the use-dependent, time-dependent measurement value by the symmetric key,
wherein the apparatus is configured to transmit the time-dependent usage performance indicator together with the encrypted measurement value and the key index in a data packet.

2. The apparatus of claim 1, wherein the symmetric key (15) is regenerated at time intervals after initiation by the key index (14) and it is possible to adjust the time intervals at which the symmetric key is changed.

3. The apparatus of claim 1, wherein the apparatus is integrated into an automation component.

4. A system comprising:
a first apparatus; and
a second apparatus,
wherein the first apparatus comprises:
a computer configured to determine a time-dependent usage performance indicator from a determined, use-dependent, time-dependent measurement value concerning a processing device, wherein an algorithm for calculation is known to a first user and a second user; and
a key generator configured to produce a key index and generate a symmetric key based on the key index, for encrypting the use-dependent, time-dependent measurement value by the symmetric key,
wherein the first apparatus is configured to transmit the time-dependent usage performance indicator together with the encrypted measurement value and the key index in a data packet,
wherein the second apparatus is configured to produce a sequence of keys, receive the key index, and produce a series of symmetric keys with aid of a start value and a pseudorandom number generator.

5. The system of claim 4, wherein the second apparatus is configured as a physical device.

6. The system of claim 4, wherein the pseudorandom number generator is configured as a linear feedback shift register.

7. The system of claim 4, wherein the pseudorandom number generator is configured to carry out a calculation according to Blum-Blum-Shub.

8. The system of claim 4, wherein a frequency with which the symmetric key is configured to be requested is restricted by the second apparatus.

9. A method for access-restricted provision of a time-dependent usage performance indicator for a processing device in a production installation for further use of a first user and a second user, the method comprising:
determining a use-dependent, time-dependent measurement value concerning the processing device;
calculating the time-dependent usage performance indicator from the determined measurement value, wherein an algorithm for calculation is known to the first user and the second user;
producing a key index and generating a symmetric key based on of the key index;
encrypting the use-dependent, time-dependent measurement value by the symmetric key; and
transmitting the time-dependent usage performance indicator together with the encrypted measurement value and the key index in a data packet.

10. The method of claim 9, wherein the data packet furthermore contains a signature of a sender.

11. The method of claim 9, wherein the key index is changed at previously known, uniform time intervals.

12. The method of claim 9, wherein further data comprising serial numbers received from another processing device or time stamps influence the generating of the symmetry key.

13. The method of claim 9, wherein the time-dependent usage performance indicator transmitted in the data packet is stored separately together with the encrypted measurement value and the key index.

14. The method of claim 13, wherein, from the transmitted time-dependent performance indicator, an invoice is linked with further user-dependent information items.

15. The method of claim 9, wherein the symmetric key is deleted after a single use.

16. The method of claim 9, wherein the processing device is an automation component and the use-dependent, time-dependent measurement value is at least one of the following measurement values per unit time from the automation component: production time, production duration, processing speed, processing intensity, expended force, or number of parts produced.

17. The method of claim 16, wherein the automation component is a machine tool.

18. The apparatus of claim 3, wherein the automation component is a machine tool.
